(19) United States
(12) Patent Application Publication
(10) Pub. No.: US 2024/0370773 A1
(43) Pub. Date: Nov. 7, 2024

(54) METHOD FOR TRAINING A MACHINE LEARNING MODEL

(71) Applicant: Robert Bosch GmbH, Stuttgart (DE)

(72) Inventors: Diane Sabine Staudt, Langenbrettach (DE); Felix Berkenkamp, Muenchen (DE); Felix Milo Richter, Tettnang (DE); Ilya Kamenshchikov, Aachen (DE); Valentin Loeffelmann, Dielheim (DE)

(21) Appl. No.: 18/644,334

(22) Filed: Apr. 24, 2024

(30) Foreign Application Priority Data
May 4, 2023 (DE) 10 2023 204 151.0

(51) Int. Cl. G06N 20/00

(52) U.S. Cl. CPC G06N 20/00

(57) ABSTRACT

A method for training a machine learning model. The method includes: ascertaining, for each of a plurality of training data elements, a gradient of a target function, wherein the gradient comprises a component for each of a plurality of parameters of the machine learning model; generating an overall gradient by averaging the ascertained gradients component-wise by summing, for each component, the values of the ascertained gradients for this component and by dividing a resulting sum for the component by the number of ascertained gradients for which the component is above a specified threshold value; and adjusting the machine learning model in a direction given by the overall gradient.

### CROSS REFERENCE

The present application claims the benefit under 35 U.S.C. § 119 of German Patent Application No. DE 10 2023 204 151.0 filed on May 4, 2023, which is expressly incorporated herein by reference in its entirety.

### FIELD

The present invention relates to methods for training a machine learning model.

### BACKGROUND INFORMATION

Many types of machine learning models are trained by ascertaining the gradient of a target function (e.g., a loss or also a reward), which gradient specifies the dependence of the target function value on parameters of the respective machine learning model (e.g., weights of a neural network). Depending on whether the target function is to be maximized or minimized, the parameters of the machine learning model are then adjusted in the direction of the gradient or in the opposite direction. The gradient is typically averaged over a plurality of training data elements, i.e., the adjustment takes place not per training data element but typically over batches of training data elements. However, the case may occur that the target function value depends on a particular parameter only for a few training data elements, and the corresponding gradient component then becomes so small as a result of the averaging that the machine learning model for such an underrepresented gradient component is practically not adjusted even though it would be necessary for some situations (which are however represented only by the few training data elements). And yet, an adjustment could be particularly important precisely for such situations because they correspond to extreme, but therefore also rarely occurring, traffic situations, for example.

Approaches are therefore desirable that improve the training for parameters underrepresented in training data.

### SUMMARY

According to various embodiments of the present invention, a method for training a machine learning model is provided, comprising ascertaining, for each of a plurality of training data elements, a gradient of a target function, wherein the gradient comprises a component for each of a plurality of parameters of the machine learning model; generating an overall gradient by averaging the ascertained gradients component-wise by summing, for each component, the values of the ascertained gradients for this component and by dividing a resulting sum for the component by the number of ascertained gradients for which the component is above a specified threshold value; and adjusting the machine learning model in a direction given by the overall gradient.

The method according to the present invention described above makes it possible to appropriately train parameters of a machine learning model even if they are underrepresented in the training data, i.e., the output of the machine learning model for most of the training data elements is not dependent on these parameters. In other words, it is avoided that the training data elements relevant to the training of such parameters are “watered down” by the high number of training data elements that are not relevant to the training of these parameters.

Various exemplary embodiments are specified below.
Exemplary embodiment 1 is a method for controlling a robot, as described above.
Exemplary embodiment 2 is a method according to exemplary embodiment 1, wherein the target function depends on rewards that are contained in the training data elements and specify rewards for state transitions caused by outputs of the machine learning model.

In other words, the machine learning model for a control task can be trained by means of reinforcement learning. Specifically in such a context, the above-described procedure achieves more efficient training.
Exemplary embodiment 3 is a method according to exemplary embodiment 1 or 2, wherein the specified threshold value is zero (e.g., in the context of computational accuracy).

For each component, a gradient value is only included in the average if it actually represents a dependence on the respective parameter. As a result, it can be avoided that training data elements that are relevant to underrepresented parameters are watered down as a result of training data elements that are not relevant to these parameters.
Exemplary embodiment 4 is a method according to one of exemplary embodiments 1 to 3, wherein the machine learning model is configured and is being trained to receive, as input, information about the kinematic state of a vehicle and to output control information for the vehicle for a driving stabilization program (e.g., ABS, ESP).

In particular in such a control scenario, parameters of the machine learning model are often underrepresented since driving is “normal” in most cases, i.e., there is no special situation in which, for example, an ESP or an ABS must intervene.
Exemplary embodiment 5 is a method for controlling a technical system, comprising training a machine learning model according to one of exemplary embodiments 1 to 4; supplying information about states of the technical system to the machine learning model; and controlling the technical system according to outputs of the trained machine learning model in response to the supplied information.
Exemplary embodiment 6 is a device configured to carry out a method according to one of exemplary embodiments 1 to 5.
Exemplary embodiment 7 is a computer program comprising commands that, when executed by a processor, cause the processor to carry out a method according to one of exemplary embodiments 1 to 5.
Exemplary embodiment 8 is a computer-readable medium which stores commands that, when executed by a processor, cause the processor to carry out a method according to one of exemplary embodiments 1 to 5.

In the figures, similar reference signs generally refer to the same parts throughout the different views. The figures are not necessarily to scale, wherein emphasis is instead generally placed on representing the principles of the present invention. In the following description, various aspects are described with reference to the figures.

### BRIEF DESCRIPTION OF THE DRAWINGS

FIG. 1 shows a vehicle according to an example embodiment of the present invention.

FIG. 2 shows a flowchart illustrating a method for training a machine learning model according to one example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented. Other aspects can be used, and structural, logical, and electrical changes can be carried out without departing from the scope of protection of the present invention. The various aspects of this disclosure are not necessarily mutually exclusive since some aspects of this disclosure can be combined with one or more other aspects of this disclosure in order to form new aspects of the present invention.

Different examples are described in more detail below.

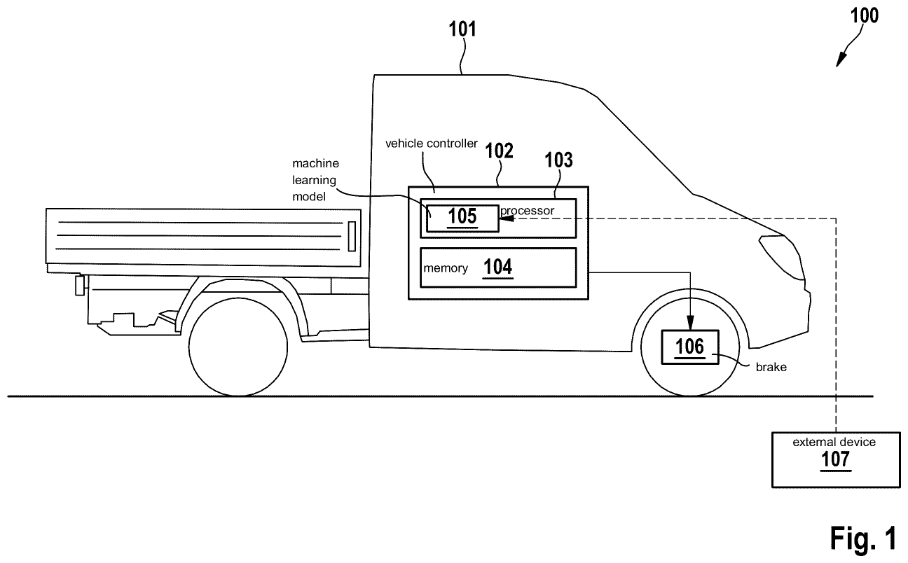

FIG. 1 shows a vehicle 101.

In the example of FIG. 1, a vehicle 101, for example a car or truck, is provided with a vehicle controller 102.

The vehicle controller 102 comprises data processing components, e.g., a processor (e.g., a CPU (central processing unit)) 103 and a memory 104 for storing control software according to which the vehicle controller 102 operates, and data processed by the processor 103.

For example, the stored control software (computer program) comprises instructions that, when executed by the processor, cause the processor 103 to implement a machine learning model 105.

The vehicle controller 102 can perform various control tasks ranging from driver assistance functions to fully autonomous driving. The respective control actions are determined by the vehicle controller 102 by means of the machine learning model 105 (i.e., the learning model 105 implements a control strategy).

For example, according to one embodiment, the vehicle controller 102 is a controller for an anti-lock brake system (ABS), i.e., generates a desired brake pressure (also referred to as input (wheel) brake pressure) for a brake 106, and is optimized using model-based learning. For example, data about the behavior of the vehicle are ascertained by means of a model (in this case, for example, pairs of entered (i.e., desired) brake pressure (over multiple time steps) and resulting velocity profile), and these data can then be used as training data for the vehicle controller 102. The vehicle controller 102 is, for example, trained by means of reinforcement learning (RL). The training of the vehicle controller 102 can consist in that the machine learning model 105 is trained on an external device 107 (training device or training (computer) system) and then loaded into the vehicle controller 102, e.g., by means of simulations (alternatively, the vehicle 101 itself can also be realized as a simulated vehicle in a simulation environment and the vehicle controller 102 can be trained in this way).

In reinforcement learning, it is attempted to train an agent (or a control strategy that the agent follows), the vehicle controller 102 (or the machine learning model 105) in the example above, such that a particular reward becomes as large as possible (for example, in the example above, depending on how successful the braking was).

In this case, rewards are typically accumulated over time steps and/or episodes (i.e., control runs) so that a cumulative reward is to be maximized by the agent. This typically takes place by adjusting parameters of the agent in the direction of the gradient of the cumulative reward, or by gradient descent, i.e., in the opposite direction to the gradient, if a loss to be minimized is used instead of a reward to be maximized.

A typical RL algorithm uses a data-driven approach and takes into account an additive target function (hereinafter a loss function to be minimized) via the parameters θ of the control strategy to be trained, on the basis of N available transitions (from a simulation or experiments) of the controlled system (e.g., the controlled device and its environment) in a data set D (e.g., in a playback buffer):

$$L ( θ ) = \frac{1}{N} {\sum }_{τ ∈ 𝒟} ℓ ( θ , τ )$$

Typical loss terms [symbol] are based on either Monte Carlo estimates of rewards (or returns) or on a critic function that assesses the performance of the actions selected by the strategy (given by the parameters θ), under parameters.

The additive loss above results in a (total) gradient

$$∇ θ = \frac{1}{N} {\sum }_{τ ∈ 𝒟} ∇ ℓ ( θ , τ ) \qquad ( 1 )$$

which is the average gradient over the data set.

This gradient can be used with any gradient-based optimization algorithm, such as gradient descent or ADAM, to adjust the parameters of the control strategy (or of a model, e.g., a neural network, that implements the control strategy).

The calculation of average gradients according to (1) and an adjustment of parameters corresponding to these gradients works well for a training of neural networks but has difficulties in the case of more localized methods such as look-up tables or linear control strategies π(s)=θ^{T}ϕ(s), wherein ϕ(s) are features of the current system state s (e.g., radial basis function features).

In these cases, most parameter gradients are equal to zero since the actions are only influenced by a subset of the parameters. In a gradient averaging as in equation (1), averaging therefore takes place mainly over zero entries, which causes problems if some parameters are only rarely active (i.e., if they only rarely influence actions).

According to various embodiments, a gradient component is therefore included in the averaging only if a gradient is present for the respective parameter (i.e., this gradient component is not zero or is above a minimum value ε; e.g., a (small) value ε is used to allow a tolerance around zero in the context of computational accuracy).

Thus, for each gradient component (i.e., for each parameter of the control strategy), an average value of the values that are above the minimum value is ascertained. This improves the training performance in practice.

Instead of averaging according to (1), the overall gradient is thus ascertained according to various embodiments by

$$∇ θ = \frac{{\sum }_{τ ∈ 𝒟} ∇ ℓ ( θ , τ )}{{\sum }_{τ ∈ 𝒟} {1}_{∇ ℓ ( θ , τ ) > ϵ}} , \qquad ( 2 )$$

where 1|∇ [symbol] (θ,τ)|>ϵ is the element-wise indicator function that provides a vector that is zero everywhere and is one for a gradient component only if the absolute value of the gradient component (which is a scalar) of the scalar gradient entry is greater than ε. That is to say, the i-th entry is one if |(∇ [symbol] (θ,τ))ᵢ|>ϵ, and otherwise zero. The division of the two vectors of equation (2) is element-wise (i.e., the i-th component of the numerator by the i-th component of the denominator yields the i-th component of the result). The threshold value ε can be selected to be equal to zero (as explained above as a small tolerance, e.g., ε=10⁻⁶).

For a control strategy realized with a look-up table (i.e., each component of θ is an entry of a look-up table that specifies the action to be performed for a respective state), this equation is equivalent to

$$∇ θ = \frac{{\sum }_{τ ∈ 𝒟} ∇ ℓ ( θ , τ )}{select ( θ , τ )} , \qquad ( 3 )$$

In this case, select (;) returns a vector of all zeros except for the entries in the look-up table that were selected from D for one of the transitions. For such an entry, the vector contains the number of transitions for which the entry was selected.

By the averaging according to equations (2) and (3), parameters of the machine learning model 105 are better taken into account in the training even if they are underrepresented in the training data set. As a simple example, the machine learning model 105 has two parameters θ1 and θ2, and θ1 is active in 90% of the training data elements (i.e., transitions) in the data set D and θ2 is active in the other 10%.

That is to say (for the sake of simplicity, there are only training data elements for ten transitions in the data set D), the gradients ∇ [symbol] (θ, τ) according to a very simple example are (1; 0), (1; 0), (1; 0), (1; 0), (1; 0), (1; 0), (1; 0), (1; 0), (1; 0), (0; 1),

wherein the first component belongs to θ1 and the second belongs to θ2.

Averaging according to (1) would provide (0.9; 0.1).

Thus, the component of the gradient for θ1 is nine times greater than that for θ2 when averaging according to equation (1). This makes it difficult to choose a learning rate that works for both parameters since the effective updates for θ1 are likewise nine times greater.

In contrast, averaging according to (2) (or (3)) provides (1; 1), whereby the machine learning model 105 is also appropriately adjusted for the underrepresented parameter θ2.

As described above, this procedure can be used for driving stabilization programs (ESP (electronic stability program), ABS, etc.). However, it can be applied to any other control strategy for a technical system that is parameterized by local guidelines, such as look-up tables. In addition, the above-described procedure can be applied not only to reinforcement learning but also to the training of machine learning models in other contexts (e.g., classification tasks, etc.).

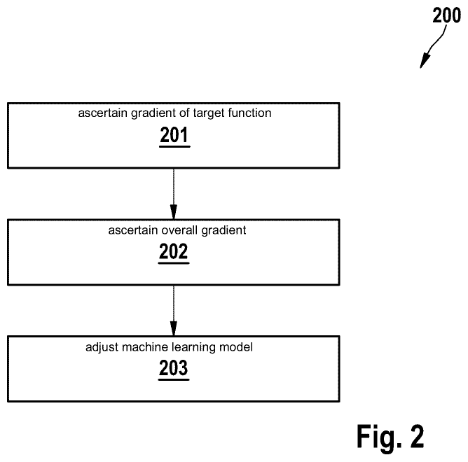

In summary, a method is provided according to various embodiments, as shown in FIG. 2.

FIG. 2 shows a flowchart 200 illustrating a method for training a machine learning model according to one embodiment.

In 201, a gradient of a target function is ascertained for each of a plurality of training data elements (e.g., a training batch), wherein the gradient comprises a component for each of a plurality of parameters of the machine learning model (e.g., for each weight of a neural network). The target function is, for example, a loss function or reward function. Ascertaining the gradient means that the gradient for the respective input for the machine learning model specifying the training data element is ascertained.

In 202, an overall gradient (or “average” gradient) is generated by averaging the ascertained gradients component-wise by summing, for each component, the values of the ascertained gradients for this component and by dividing a resulting sum for the component by the number of the ascertained gradients for which the component is above a specified threshold value (the result of this division is then the value of the component of the overall gradient).

In 203, the machine learning model is adjusted in a direction given by the overall gradient (in the direction in which it points if the target function is to be maximized (reward), or in the opposite direction if it is to be minimized (loss)).

The method of FIG. 2 can be carried out by one or more computers comprising one or more data processing units. The term “data processing unit” can be understood to mean any type of entity that enables the processing of data or signals. The data or signals can, for example, be processed according to at least one (i.e., one or more than one) specific function carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the respective functions described in more detail here can also be understood as a data processing unit or logic circuitry. One or more of the method steps described in detail here can be performed (e.g., implemented) by a data processing unit by means of one or more specific functions carried out by the data processing unit.

According to various embodiments, the method is thus, in particular, computer-implemented.

After the training, the machine learning model can be applied to sensor data ascertained by at least one sensor. The output of the machine learning model thus provides a result about a physical state of an environment of the at least one sensor and/or of the at least one sensor itself, or the method can comprise using, as such a result, the output of the trained machine learning model that it provides in response to an input of sensor data.

In other words, the method can comprise deriving or predicting the physical state of an existing physical object on the basis of measurements of physical properties (i.e., sensor data relating to the object) by means of the trained machine learning model (i.e., its output in response to the sensor data).

For example, after the training, the machine learning model is used to generate a control signal for a robotic device by supplying the machine learning model with sensor data relating to the robotic device and/or its environment. The term “robotic device” can be understood as relating to any technical system (with a mechanical part whose movement is controlled), such as a computer-controlled machine, one or more vehicles, a household appliance, an electric tool, a manufacturing machine, a personal assistant, or an access control system.

Various embodiments can receive and use sensor signals from various sensors, such as video, radar, LiDAR, ultrasound, movement, thermal imaging, etc., for example in order to obtain sensor data with regard to states of the respective technical system and configurations and scenarios. The processing of the sensor data by the machine learning model can comprise classifying the sensor data or performing a semantic segmentation of the sensor data, for example in order to detect the presence of objects (in the environment in which the sensor data were obtained). Embodiments can be used to train a machine learning system and to control a robot, e.g., by robot manipulators autonomously in order to accomplish various manipulation tasks under various scenarios. In particular, embodiments are applicable to the control and monitoring of the performance of manipulation tasks, e.g., in assembly lines.

What is claimed is:

1. A method for training a machine learning model, comprising the following steps:
ascertaining, for each of a plurality of training data elements, a gradient of a target function, wherein each of the gradients includes a component for each of a plurality of parameters of the machine learning model;
generating an overall gradient by averaging the ascertained gradients component-wise by summing, for each component, values of the ascertained gradients for the component and by dividing a resulting sum for the component by a number of the ascertained gradients for which the component is above a specified threshold value; and
adjusting the machine learning model in a direction given by the overall gradient.

2. The method according to claim 1, wherein the target function depends on rewards that are contained in the training data elements and specify rewards for state transitions caused by outputs of the machine learning model.

3. The method according to claim 1, wherein the specified threshold value is zero.

4. The method according to claim 1, wherein the machine learning model is configured and is being trained to receive, as input, information about a kinematic state of a vehicle and to output control information for the vehicle for a driving stabilization program.

5. A method for controlling a technical system, comprising the following steps:
training a machine learning model including:
ascertaining, for each of a plurality of training data elements, a gradient of a target function, wherein each of the gradients includes a component for each of a plurality of parameters of the machine learning model,
generating an overall gradient by averaging the ascertained gradients component-wise by summing, for each component, values of the ascertained gradients for the component and by dividing a resulting sum for the component by a number of the ascertained gradients for which the component is above a specified threshold value, and
adjusting the machine learning model in a direction given by the overall gradient;
supplying information about states of the technical system to the machine learning model; and
controlling the technical system according to outputs of the trained machine learning model in responses to the supplied information.

6. A device configured to training a machine learning model, the device configured to:
ascertain, for each of a plurality of training data elements, a gradient of a target function, wherein each of the gradients includes a component for each of a plurality of parameters of the machine learning model;
generate an overall gradient by averaging the ascertained gradients component-wise by summing, for each component, values of the ascertained gradients for the component and by dividing a resulting sum for the component by a number of the ascertained gradients for which the component is above a specified threshold value; and
adjust the machine learning model in a direction given by the overall gradient.

7. A non-transitory computer-readable medium on which are stored commands training a machine learning model, the commands, when executed by processor, causing the processor to perform the following steps:
ascertaining, for each of a plurality of training data elements, a gradient of a target function, wherein each of the gradients includes a component for each of a plurality of parameters of the machine learning model;
generating an overall gradient by averaging the ascertained gradients component-wise by summing, for each component, values of the ascertained gradients for the component and by dividing a resulting sum for the component by a number of the ascertained gradients for which the component is above a specified threshold value; and
adjusting the machine learning model in a direction given by the overall gradient.
